(19) United States
(12) Patent Application Publication
(10) Pub. No.: US 2007/0218450 A1
(43) Pub. Date: Sep. 20, 2007

(54) System for obtaining and integrating essay scoring from multiple sources

(75) Inventors: Kevin M. MacClay, Newtown, PA (US); Brian Maguire, New Hope, PA (US); Kun Hang, Warrington, PA (US)

Correspondence Address: PAUL AND PAUL, 2000 MARKET STREET, SUITE 2900, PHILADELPHIA, PA, 19103, US

(73) Assignee: Vantage Technologies Knowledge Assessment, L.L.C.

(21) Appl. No.: 11/366,142

(22) Filed: Mar. 2, 2006

(51) Int. Cl. G09B 7/00

(52) U.S. Cl. 434/353

(57) ABSTRACT

A method and a web-based software apparatus for use in the automated scoring of assessment test papers, utilizes both a human and the machine scoring of each paper in a poly-metrological evaluation each assessment score. The scoring performance of each human scorer, in web-base assessment scoring production, is constantly monitored and evaluated, in real time, for score accuracy, bias, and other factors. Whereof, each human score performance is measured against machine score performance of the same assessment paper, and if need be, against a second human score performance in scoring the same assessment paper. Scores are resolved according to a subscriber approved algorithm. Irresolvable discrepancies are addressed by a chief or master human scorer. The score performance history of each production, human scorer is constantly monitored, in real time, and each human scorer is prompted or selected-out for retraining, as necessary, according to a selected, real time, evaluation algorithm. Scorer performance is judged according to exact agreement rates, and according to adjacent agreement rates.

### BACKGROUND OF THE INVENTION:

The present invention is directed to a system and a method for scoring essays, and reporting on the score of essay answers, such as used for standardized achievement tests or for teaching essay drafting in literature.

Standardization of the scoring process for scoring essays has taken generally two separate and distinct approaches. The first is to have trained human scorers read and score an essay. The second is for a machine to read and score the essay according to a predetermined algorithm based upon a human scoring model. The standardization and accuracy of essay scoring are complex problems that have been of interest for many years. There is considerable pressure to optimize the efficiency, accuracy, speed, and the repetitiveness and therefore the reliability of such essay scoring.

Hardware has improved throughout the years. Generally, today an essay is scored after it has been put into electronic format, either by a student typing the essay on-line at a workstation, or by reading a paper essay with an optical character reader (OCR) scanning system.

Standardization of testing involves determining a uniform scoring of the essay tests by human scorers. National Computer Systems, Inc. (“NCS”) has developed a computerized administration system for monitoring the performance of a group of scoring individuals grading open-ended essay answers of the same test which has been administered to a group of examinees. Tests are scanned and then presented to scoring individuals over a LAN system. A computer system monitors the work performance of each scorer; and then compares the production, decision making, and work flow of the scoring individuals against a database established “norm”; and then provides feedback and on-line scoring guidelines to the individual scorers, as well as adjusts their work volume and work breaks.

Educational Testing Service, Princeton, NJ (“ETS”), has developed a LAN based workstation system for human evaluators that controls the presentation of essay answers to the human evaluators in order to minimize the influence of psychometric factors on the accuracy of the human evaluators. The performance of human evaluators to test questions is monitored and evaluated against a performance guideline database. The system also manages the work distribution to the human evaluators and the work flow during any real-time, on-line testing period.

Along with this, there has been developed a computerized test development tool for the monitoring and the evaluation of both its human evaluators and the proposed essay test questions to which the examinees are to be presented. Responses to proposed questions are constructed by research scientists and are categorized based on descriptive characteristics indicating the subject matter of interest. The constructed answers are presented to the human evaluators working at individual workstations and their score is assembled into a database for later evaluation by the test developers for the appropriateness of the test questions and the ability of the human evaluators to score answers.

Typically, the performance results of a scoring individual are periodically checked against an expert scorer. When a human scorer's scores are out of tolerance, the scorer is prompted with tutoring remarks.

In the development of the questions for standardized tests, tools have been developed, i.e., system tools, to assist in generating rebuics for use in computerized machine scoring of essay answers. Computer scoring, i.e., electronic scoring, of essays has taken several different approaches.

One method for computer scoring essays is to compare a submitted essay to an ideal essay on the same topic. This is done by electronically searching the examinee essay for textual terms, i.e., textual content of the essay relating to the topic, coding the terms found, and then comparing the list of examinee terms to that of the ideal essay. In a similar computer method, the ideal essay is used to construct a taxonomy evaluation system. The examinee essay is then scanned for terms which are compared against the taxonomy “tree” to provide a score.

Computer methodology has taken other forms, such as first parsing the examinee essay to produce parsed text being a syntactic representation of the essay. Thereafter the parsed text is used to create a vector of syntactic features, and to create a vector of rhetorical features. A content program evaluates the content terms of the essay and an argument content program evaluates the logic terms. A scoring algorithm then calculates a final score from these factors.

Parsing and parse trees are useful in content-based computer essay scoring systems. In another system a parse tree file generated from an examinee essay is compared with a parse tree file generated from the ideal essay. This is conducted by using a morphology stripping program to first scan the essay and then a concept extraction program to create a phrasal node file. A scoring program scores the essay from the phrasal node file.

In another computer scoring system, an essay is analyzed by determining whether each of a predetermined set of features (such as fact terms or fact phrases) is present or absent in each sentence of the essay. The probability that each sentence is a member of a certain discourse element category is calculated based on the features or set of features found. Scoring is then conducted on these findings.

Another computer-based essay scoring system performs certain tasks in evaluating an examinee essay prior to scoring it. The methodology compares an examinee essay text to a reference text. The amount of subject-matter information, the relevance of the subject-matter information, and the semantic coherence are scored. The system then parses and stores text objects and segments in a two-dimensional data matrix. A weight is assigned to each text object and applied to each data matrix cell. A singular value decomposition is performed on the data matrix to produce three trained matrices. A vector representation is computed. The cosine between the vectors is determined. This cosine value is compared to the ideal essay text. Alternately, a dot product is used to compare parsed segments of an examinee text to ideal text. A score is assigned based upon degree of similarity.

A similar computer-based system uses trait models for comparing an examinee essay to an ideal essay. Here a trait is one or more substantially related essay features and /or feature sets, e.g., misspelling, improper capitalization, word usage, repetitious word use, inappropriate word use, etc. Each trait or trait model is defined by a mathematical sequence. Trait evaluation is conducted on parsed sections of the examinee essay. Each parsed section is compared against each trait model and a score is generated.

These human scoring and computer scoring systems have had certain shortcomings. Human scorers are not consistent in their performance. Often two scorers will not score the same essay identically. Even the same scorer will not score the same essay identically twice.

Human scorers typically use a holistic scoring approach in which an essay is first read over quickly for an overall impression and readability. The essay is then read more tediously for content, grammar, style, organization, and other factors. A score is then issued. In using a holistic approach, the performance of the human scorer is typically improved by increasing the number of criteria to be examined by the scorer and then placing the score for each criterion into a weighting and averaging algorithm to produce an overall score.

However, it has been experienced with past computer-based essay scoring systems, that when the number of criteria to be evaluated by a computer-based essay scoring system exceeds a relatively low number (threshold number) the performance of the computer-based system begins to degrade as the number of criteria is further increased. Therefore, many computer-based essay systems today make use of relatively small sets of criteria. This may, in turn, result in some scoring anomalies and may account for some differences in scores between human scorers and conventional computer-based essay scoring systems.

However, as computer-based essay scoring systems continue to improve their use increases in both high-stakes assessment programs and low-stakes assessment programs. Currently, there are a number of automated essay scoring systems, and their applications vying in the marketplace. Among these are: PROJECT ESSAY GRADE (PEG); INTELLIGENT ESSAY ASSESSOR (IEA); INTELLIMETRIC; COMPASS E-WRITE; E-RATER; BAYESIAN ESSAY SCORING SYSTEM (BETSY); and PANILINGUA.

Typical of these is E-RATER which focuses on three general classes of essay features: structure (indicated by the syntax of sentences); organization (indicated by various discourse features that occur throughout extended text); and content (indicated by prompt-specific vocabulary).

Computer-based essay scoring systems have several obvious advantages over human scorers, which include: a) time and resources (including speed) to examine very large amounts of material (numbers of essays); repetitiveness of results for a given essay scored; free of scoring drift due to fatigue, boredom, psychological factors; and free of random bias.

However, a computer system is only as good as the computer programmers who programmed it. Therefore, automated scoring has yet to prove better than human scoring when human scoring is exhibited at its best.

In the past, in the scoring of important examinee essay tests, two human scorers were utilized and their scores compared. If the scores disagreed, then a third scorer was engaged, who presumably resolved the scoring conflict. This became an excessive use of manpower. To maintain peak human scorer performance, work breaks, work flow monitoring, scoring performance monitoring by periodically “surprise testing” the human scorer against an ideal score, and other expense generating techniques have been utilized.

More recently, some high-stakes assessment programs, such as with the Analytical Writing Assessment of the Graduate Management Admission Test, have begun rating essays with a single human scorer and thereafter rating the same essay by the E-RATER computer-based system. The introduction of machine scoring reduces the previous manpower requirements of having a first scorer and then a second scorer rate the same essay. This dual human-machine rating system serves as an off-line human scorer performance management tool. When a machine generated score does not match the human generated score, an expert scorer thereafter rates the essay to resolve the differences.

In the past, there has been no quality control monitoring of the performance of a computer-based scoring system. Once a computer-based system has passed beta testing, it is presumed that its future performance is reliable. This presumption does not take into account the above-referenced anomalies which can occur with increasingly sophisticated testing.

Expert scoring systems provided by major scoring vendors often show exact agreement scoring rates, between duplicate human scorers of professional essay examinations, of a low as 40%; while adjacent agreement scoring rates are around 90%. Electronic (computer-based) scoring systems, while offering the promise of improvements in scoring accuracy, provide even lower results (c.f., Myford and Cline2002 paper on GMAT scoring).

What is desired is an improved system which reduces the need for excessive monitoring and the regular, periodic testing of human scorer performance.

What is secondly desired is an improved system which reduces the need for redundant human scoring of examinee essays by utilizing machine scoring.

What is further desired is a real-time checking and resolution system with tandem essay scoring between a human scorer and a machine scoring.

What is also further desired is a method of real-time resolving of discrepancies in scoring for an examinee essay.

What is even further desired is a real-time monitoring system and method which checks the human and machine scoring system performance for every examinee essay and generates any needed corrective action.

### SUMMARY OF THE INVENTION

An objective of the present invention is to provide an assessment paper scoring system, having a method and a software implementation, providing integrated scoring from multiple sources to yield a poly-metrological evaluation for generating a final score for each assessment paper being scored. An assessment paper is an examinee's answer, in paragraph format, to an assessment question, presented as paper based and then digitized by scanning, or presented in web-based (electronic) information.

Each assessment paper is scored by a trained, production, human scorer, who submits his score with the assessment paper identification to a monitoring and adjusting system. When an assessment paper score is received from a particular human scorer, that assessment paper is immediately also scored by a computer based scoring software operating according to a design rubric. The human score and the machine score are then immediately compared for exact agreement and for adjacent agreement. Scores within exact agreement are stored in a results database with the paper identification. Scores within a predetermined adjacent agreement are averaged and rounded and then sent to the results database. Assessment papers whose scores are outside of the predetermined adjacent agreement threshold value are immediately copied to a second human scorer for scoring resolution.

The second production human scorer's assessment paper score is submitted to the system and is compared against each of the first human scorer's score and the machine score for that particular assessment paper. When the three scores are compared, if any two of them are in exact agreement, or any two are within adjacent agreement, the third score is discarded. The two scores in agreement are then processed, first recited above in situations which did not require a third score. The resultant score with its paper identification sent to the system database.

Irresolvable discrepancies occur when the three scores are outside of the predetermined adjacent agreement threshold with respect to each other. In that case, the three scores and the irresolvable assessment paper are then sent chief or master human scorer for review and assignment of a score. The master human scorer's assigned score is then sent to the system database with the paper identification.

The system also tests new human scorers and tests returning and/or retrained human scorers. New scorers are administered a certification test which contains a plurality of items. New scorer performance in scoring the certification test is evaluated against stored theoretically correct /accurate test scores. If a new human scorer's performance is unsatisfactory, he/she is trained further. If his/her performance is satisfactory, the scorer is certified, assigned an identification code/workstation and assigned work.

Each returning and/or retrained human scorer is given three to five assessment papers to score during a re-certification process. The human scores are compared against a reference score database for each assessment paper. If the tested human scorer shows satisfactory performance with the first three assessment tests, he /she is re-certified and assigned work. If the performance is not-satisfactory, two additional assessment papers are scored and compared against the database reference scores for those assessment papers. The human scorer is then re-trained according to an analysis of the scorer's performance and the resultant non-exact agreement and non-adjacent agreement scores generated by the human scorer in scoring the total of five assessment papers.

When at work, each production human scorer's performance is constantly monitored in real time. If it is determined that the human scorer has produced three non-exact agreement scores in succession, which are albeit within the adjacent agreement threshold, either high or low, an alert instruction appropriate to the human scorer's immediately preceding performance is immediately sent to that human scorer. If three successive human scores contain one score outside the adjacent agreement threshold, that human scorer is alerted to stop scoring and become re-certified. If five successive human scores are each in non-exact agreement, while albeit they are in adjacent agreement, either high or low, that human scorer is alerted to stop scoring and become re-certified.

The present invention provides a vehicle for training and testing human scorers. This invention optimizes essay assessment scoring based on scoring from various or plural sources. It provides automated (machine) scoring integrated with human scoring. It also provides real time monitoring of human scorer behavior.

The automatic monitoring of human scorer performance begins with a certification of satisfactory performance against a training set of assessment paper. It also provides automatic prompts when a scorer's performance is within acceptable adjacent agreement rates, but not within exact agreement. This results in additional training while production scoring.

The system can be modified for alternative scoring source algorithms, and for alternative score discrepancy resolution algorithms. The purpose is to optimize scoring and score adjustment based on human and electronic integration of human and electronic scoring. Decision making is optimized based on various sources of input.

Multiple machine rubrics may also be utilized, including four independent scoring rubrics for: 1) focus; 2) organization; 3) spelling and grammar; and 4) content.

Scoring algorithms may calculate scores on selected scales, such as for example 0 to 4, or 0 to 6, or 0 to 8. Score averaging may be selected as whole and partial number or rounded up or down as the rubric algorithm chosen dictates. Adjacent agreement thresholds may be selected depending upon scoring scales and can be deviations from 1 to 2 or 3. Further, web-based portals can provide real time score monitoring, statistics on volumes scored, agreement rates, and scoring distributions.

For certification and retesting reference scores for pre-scored certification/retesting papers are stored in a database along with the associated base score and acceptable deviation.

### BRIEF DESCRIPTION OF THE DRAWINGS

The features, advantage and operation of the present invention will become readily apparent and further understood from a reading of the following detailed description with the accompanying drawings, in which like numerals refer to like elements, and in which:

FIG. 1 is block diagram of a system for scoring essays, monitoring performance, certification and training and reporting results;

FIG. 2 is a logic diagram for on-line human scorer certification;

FIG. 3 is a logic diagram for returning/retrained human scorers;

FIG. 4 is a logic diagram for human scorer on-line score adjusting;

FIG. 5 is a logic diagram for an alternate sequence for human scorer adjustment of FIG. 4;

FIG. 6 is a logic diagram for plural human scorer on-line score adjustment;

FIG. 7 is a logic diagram for human scorer to machine score adjustment;

FIG. 8 is a table of scoring rubrics;

FIG. 9 is a table of scale, adjacency and weighting algorithmic selection;

FIG. 10 is a logic diagram for periodic, random re-certifying;

FIG. 11 is a logic diagram for human scorer performance monitoring;

FIG. 12 is a logic diagram for human scorer assignment control;

FIG. 13 is a logic diagram for profiling scorer performance; and

FIGS. 14-17 is a logic diagram for operating selected multiple human-machine scoring algorithms.

### DETAILED DESCRIPTION OF THE INVENTION

The present invention is an essay assessment paper scoring system for human scorer and machine scoring integration and the monitoring and management thereof. Reports of assessment scores and monitoring and management are available from database reports.

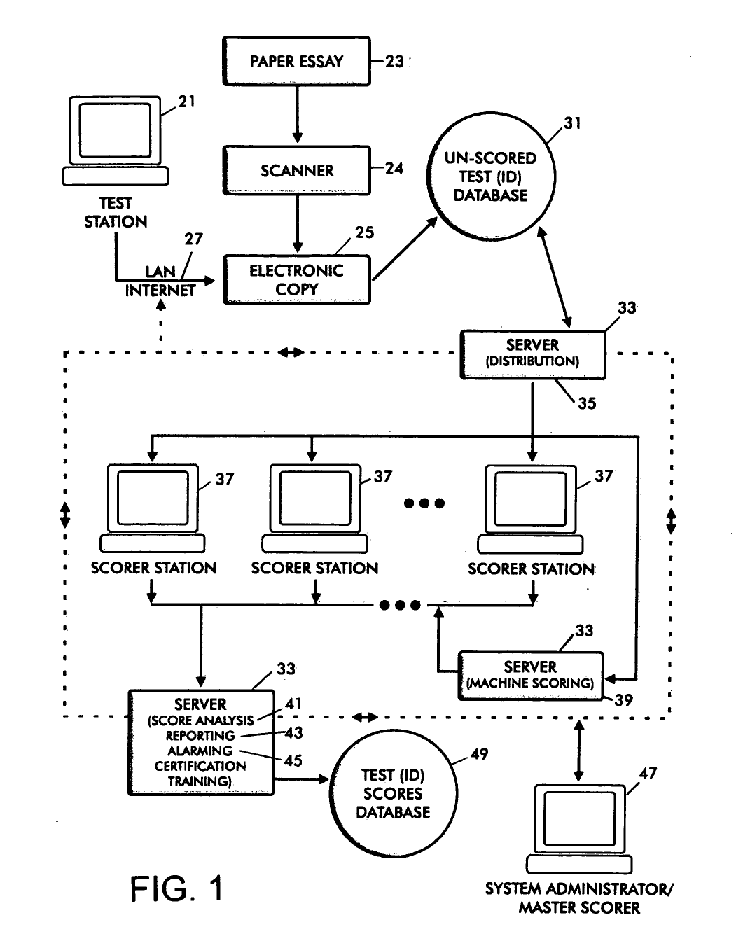

Within the system, assessment test essay papers are received either from on-line test stations 21, FIG. 1, or from paper essays 23. Test station 21 assessment results are available as electronic copy 25 by LAN or internet connection 27. Paper essays 23 are scanned in a scanner 29 into electronic copy 23. The electronic copies 25 are stored with each papers identification code in and un-scored test database 31.

The system server, which may be implemented in on machine or a plurality of stacked machines, takes un-scored tests from the database 31 and distributes/assigns 35 them to individual scorer workstations 37 and to the machine scoring engine 39 resident in the server 33.

Assessment test scores, with their paper's identification, are sent to the server 33 for scoring analysis 41, reporting 43, and alarming 45. When necessary to resolve and irregularity and/or a discrepancy, the test paper electronic copy 25 is sent to master scorer 47 for score resolution. The master scorer 47 also functions as the system administrator when an alarm 45 and associated report 43 are generated.

Once a score is resolved the test score and its associated identification are stored in a test scores database 49. The server 33 makes test scores and results reports available via the LAN /internet connection 27. Human scorer certification 51 and /or human scorer training (or retraining) 53 are administer by the server 33 to human scorer(s) at workstations 37. The status of each human scorer is managed by the server software discussed below.

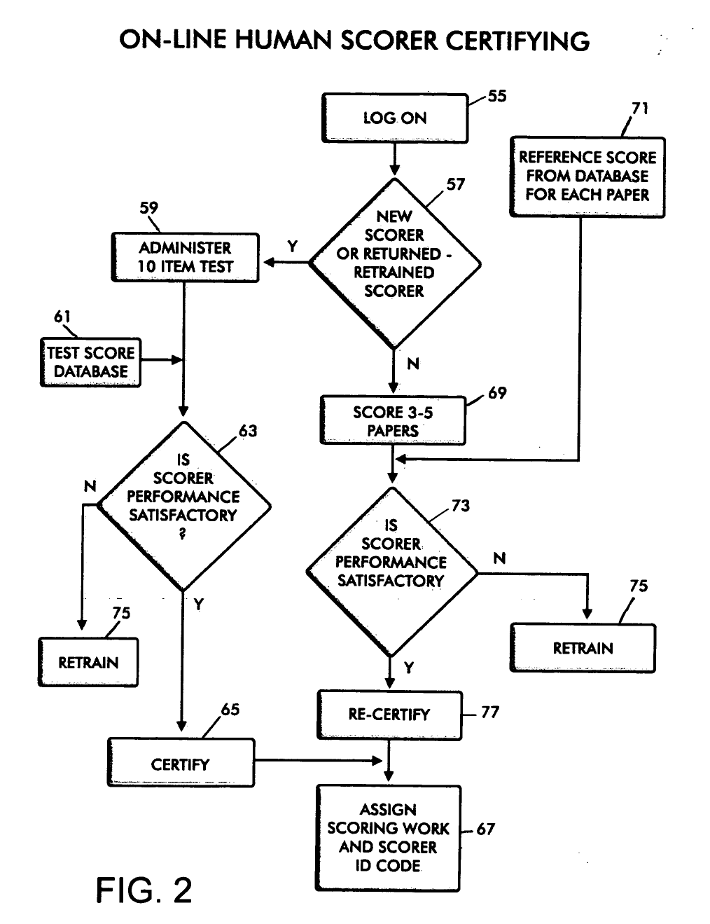

As precedent to a human scorer being assigned a workstation 37, he/she must be trained and certified. Scorers whose performance degrades and are assigned to be re-trained, are notified to that effect and stop scoring until they are thereafter re-certified. The certification process begins with the candidate scorer logging-on, step 55, FIG. 2, at a workstation. The candidate is quizzed as to his/her status being a new scorer or a returning or re-trained scorer, step 57. If the candidate is a new scorer a 10 item test is administered 59 and the correct or theoretically accurate scores are obtained from a database 61. It is then determined if the scorer performance is satisfactory 63. If yes, the scorer is certified 65 and then assigned a scorer identification code and assigned work 67. If no, the human scorer is retrained 75.

Returning to step 57, if the logged-on candidate is not a new scorer but a returned or retrained scorer then he/she is assigned between 3 and 5 papers to score, step 69. The reference or theoretical ideal score for each paper is obtained from a database 71, and the scorer performance in scoring each paper is compared against the satisfactory standard 73. If the scorer's performance is not satisfactory the scorer is returned for retraining, step 75. If the scorer's performance was satisfactory, he/she is re-certified, step 77, and then assigned a scorer identification code and assigned production work 67.

The rubric selected to determine satisfactory performance, in steps 63 and 73, can vary for the type of assessment testing being to be scored. Examples are bar admissions testing, SAT testing, grade-level, incremental-achievement testing. Examples of satisfactory performance are determined by comparing the candidates generated score for each paper scored against the theoretically correct /accurate test score for each paper and determining if the candidates graded score is in exact agreement or adjacent agreement. Examples of satisfactory performance can be: 3 of 3 in exact agreement; or 3 of 4 in exact agreement and 1 of 4 in adjacent agreement; or 3 of 5 in exact agreement and 2 of 5 in adjacent agreement. Lesser standards could take forms where the scorer performance was always within adjacent agreement or better.

The scale for determining adjacent agreement could likewise be varied depending upon the type of tests to be scored. Acceptable adjacency could be: plus or minus 1 on a 0-6 scoring scale; or plus or minus 2 on a 0-20 scoring scale. The standards for the rubrics and algorithms are determined by such factors as the importance of the test, the judgment of the system administrator /chief human scorer, and the desires of the test administering agency or school system administering the assessment tests being scored.

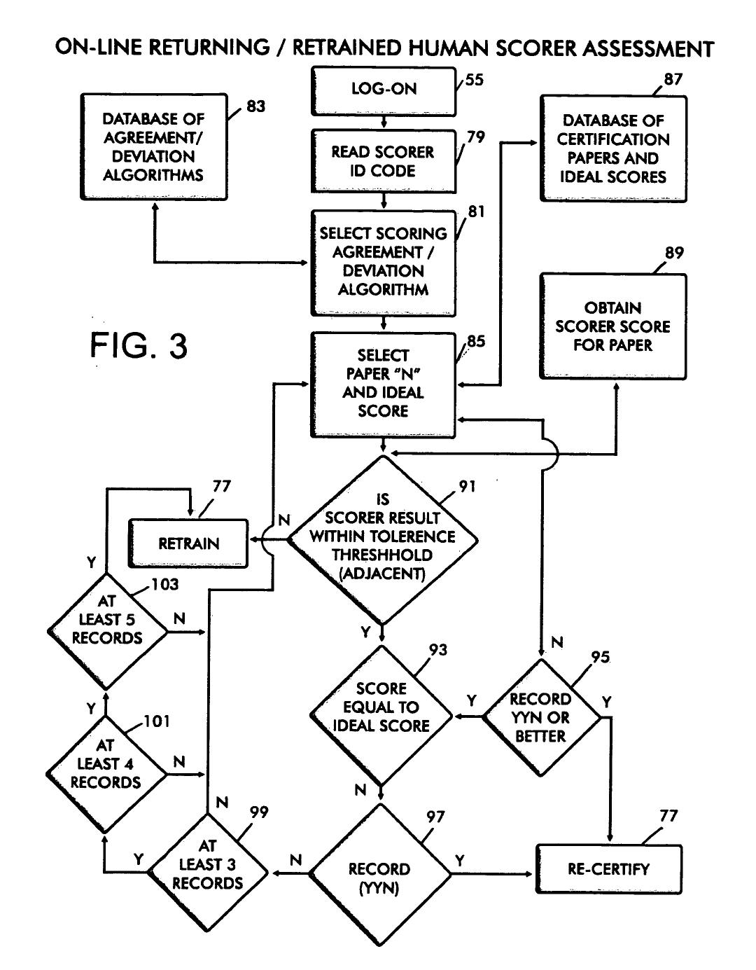

Using these parameters, returning and retrained human scorer performance is assessed by the system, FIG. 3. This process assessment process may be inserted into a human scorer's workstation work queue before production work is permitted to begin. Having logged-on 55, the human scorer identification code is read, step 79, and then the values for score agreement, i.e., adjacent agreement, are selected and entered, step 81, from a database of possible and acceptable parameters 83 for the scoring proficiency algorithm. A certification paper is randomly selected 85 for scoring from a database of certification test papers 87 with its corresponding ideal score. The human scorer scores the selected paper, step 89, and the human scorer performance is compared to the ideal score for an acceptable adjacent agreement, step 91. If the human score is within the adjacent range, it is then determined if the human score is in exact agreement, step 93. If yes, the assessment history for this human scorer to determine if a passing record for the number of papers scored is present, step 95. If a record of three successive successful performances is complete, the human scorer is assessed as re-certified 77 and that date and time and parameters or re-certification of that human scorer are recorded in an appropriate database.

If in step 95 a record of three successive successful performances is not complete is not complete, the human scorer is assigned a further certification paper to score and the steps 85-95 are repeated. If in step 93 the human score is not equal to the ideal score the human score record is examined for three successive successful performances, step 97. If it is the human scorer is re-certified 77 and the database records are updated on that human scorer.

If in step 97 there is not a successful record, the record is examined for having at least three certification paper records, step 99. If there are not, then the process returns to step 85 and obtains, step 87, a further certification paper. If there are at least three records, then the human scorer history is examined for at least four records, step 101. If there are not four records, then the process returns to step 85 and a further certification paper is obtained 87.

If there are at least four records, then the human scorer history is examined for at least five certification paper records, step 103. I there are not five records the process returns to step 85 and obtains a further certification paper 87

If there are five records, then the human scorer is sent an alert notice, must stop production scoring, and be retrained 77.

In step 91, if an human score for a certification paper is outside of the tolerance threshold for an adjacent score, the human scorer is sent an alert notice, must stop production scoring out of the queue of papers at his/her workstation, and be retrained 77.

This human scorer performance assessment against ideal scores for certification papers may be also inserted into a human scorer's work queue at anytime to monitor that human scorer's performance against ideal and adjacent scores for known certification papers.

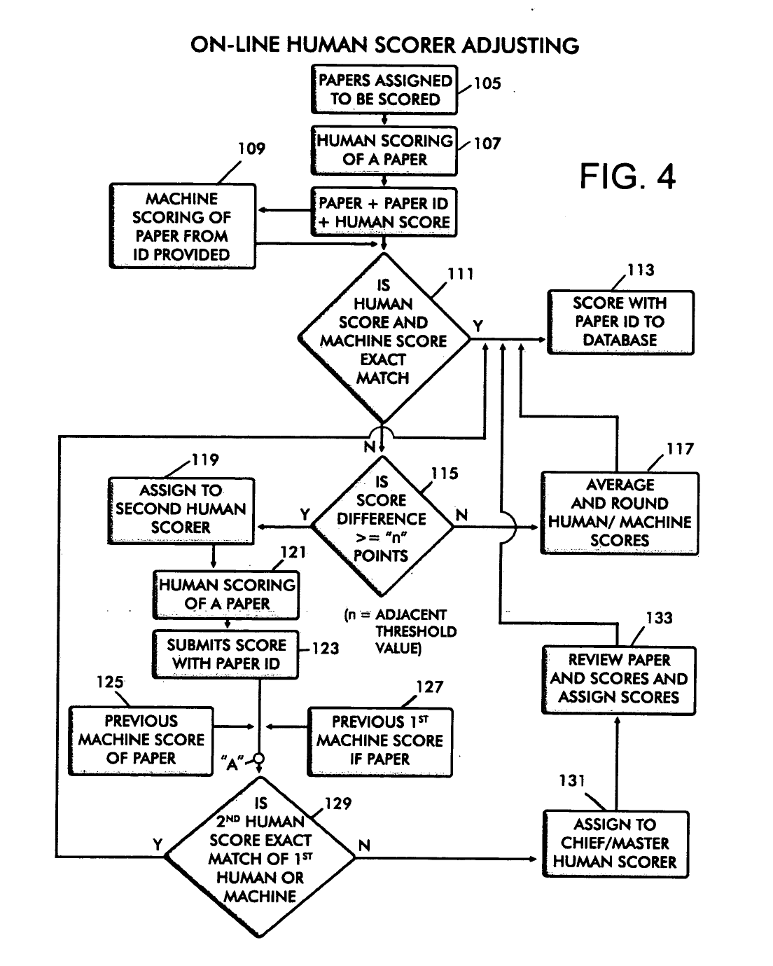

In the production scoring from multiple sources in the system of the present invention, multiple score sources, such as a human scorer and a machine scoring engine, FIG. 4, are utilized and the adjustments of scores may occur to produce a resultant assessment test paper score. Papers are obtained from the un-scored test paper database 31, FIG. 1, and assigned to a workstation be scored, step 105, FIG. 4. The paper is downloaded into the work queue, in the on-site storage at the workstation, from which it is selected in turn and scored by the human scorer at that workstation, step 107. The paper and the paper ID are also passed to a machine scoring engine 109 and machine scored. The human score and the machine score are then compared for exactness, step 111. If they are exact, then the score and the paper ID are sent to the database 49 of test scores, step 113. If the scores are not exact, then they are examined for acceptable adjacency, step 115. If there is acceptable adjacency, then the human and machine scores are averaged and rounded according to the select algorithm and rubric parameters pre-selected to the particular production scoring run, step 117, and the resultant score and paper ID are sent to the scored paper database, step 113.

If the human score is out of acceptable adjacency with the machine score, step 115, the paper is assigned to a second human scorer, step 119. This second human scores the paper, step 121 and submits the second human scorer score and paper ID (to the server) where the previous machine score 125 and previous first human scorer score 127 are held. The three scores are compared to determine if the second human scorer score is an exact match to the machine score, step 129. If it is that score is assigned to the paper and the paper and ID are sent to the database, step 113. If they are not, the paper is assigned to the chief or master human scorer, step 131. The chief human scorer thereafter reviews the paper and scores it, step 133, and the score and paper ID are sent to the database, step 113.

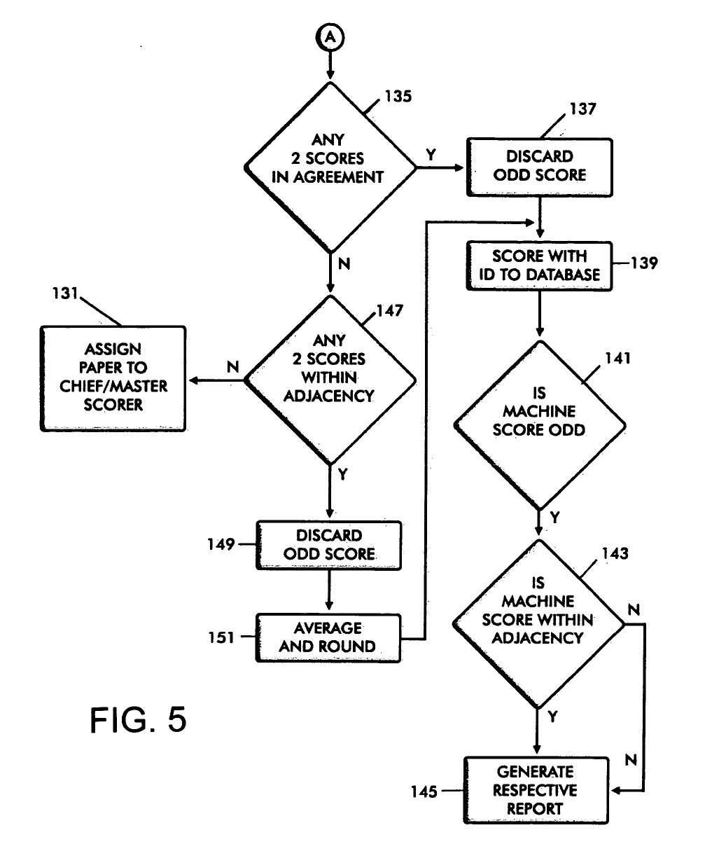

There can exist a parallel processing leg to the process of FIG. 4. This parallel processing leg begins at point “A”, FIG. 4, after the second human scorer scores the same paper in step 123 and the machine and first human scores are obtained, steps 125,127. The logic diagram for this parallel processing leg is shown in FIG. 5. Here the first and second human scores and the machine scores are examined for exact agreement between any two of them, step 135. If yes, discard the odd score, step 137 and send score with ID to the database, step 139. If the machine score was the odd score discarded, step 141, the scores are examined to determine if the machine score was within the tolerance for adjacency, step 143. If it is, a respective report indicating the facts is generated, step 145. If it is not, a respective report is generated, step 145, to those facts.

If in step 135, no two scores are in exact agreement, then the three scores are examined to determine if any two of them are in adjacency agreement, step 147. If two are, then the odd score is discarded, step 149, the adjacent scores are averaged and rounded, step 151, and the score is sent to the database with its ID, step 139. Thereafter steps 141,143 and 145 are performed.

If in step 147, no two scores are within adjacency, the paper is assigned to the chief/master human scorer 131 and the process continues as in FIG. 4.

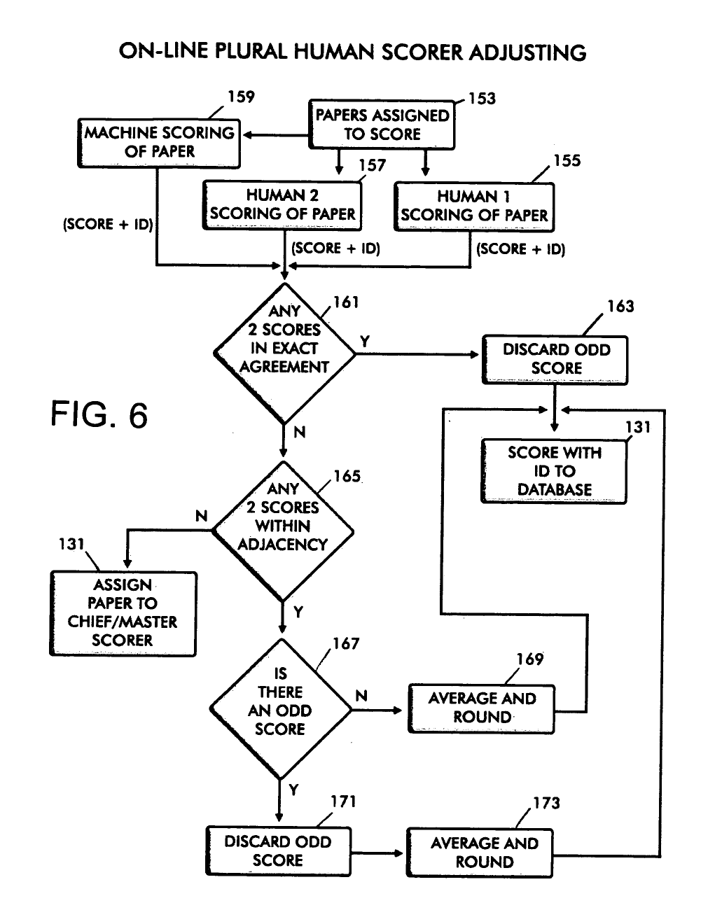

Plural human scorer score adjusting can also be carried out by the system, FIG. 6. In this routine multiple human scorers can be incorporated with machine scoring of each essay paper in the operation of the system. FIG. 6 shows where the electronic copy of a test paper to be scored is assigned 153 to a first human scorer 155, a second human scorer 157 and machine scoring 159 simultaneously. Each scoring medium (155,157,159) generates a score and paper ID. Thereafter the process continues in similar manner to FIG. 5. Specifically, FIG. 6, if any two scores are in exact agreement, step 161, the odd score is discarded, step 163 and the score and paper ID is sent to the database, step 131.

If no two scores exact, the scores are examined for two in adjacent agreement, step 165. If there is not adjacency, the paper is assigned to the chief/master scorer, this being step 131. If there is adjacency, the scores are examined for an odd score, step 167. If there is none, the three scores are averaged and the average is rounded, step 169. If there is an odd score, it is discarded, step 171 and the two adjacent scores are averaged and the average is rounded step 173. The results, i.e., the resultant score and ID, from step 169 and/or from step 173 are each sent to the database, this being step 131.

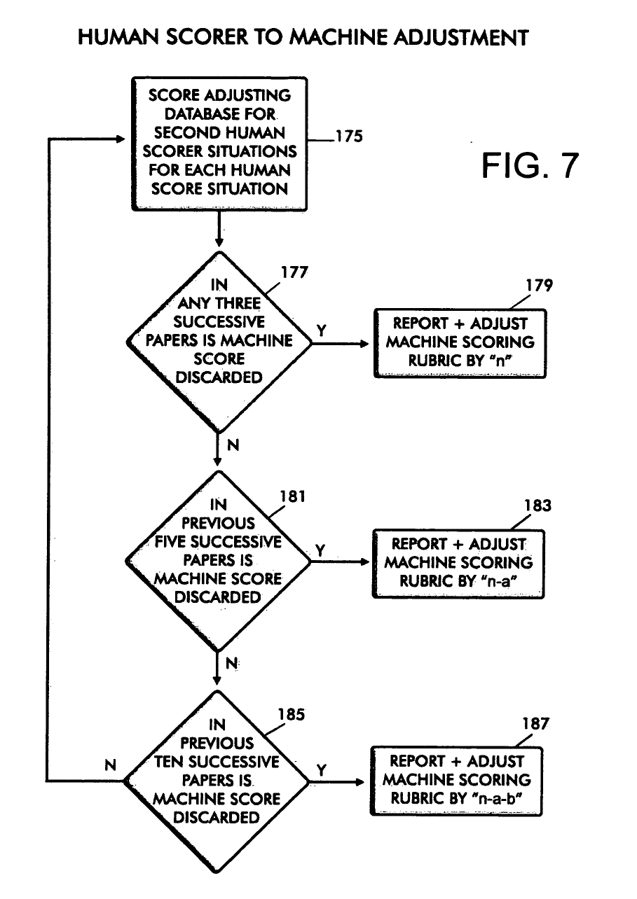

Depending upon the production run of tests being scored, and the algorithm and rubric parameters selected, the machine scoring engine may need to be adjusted to meet satisfactory production scoring. Human scorer performance to machine adjustment, FIG. 7, can include a database 175 of scoring facts where a second human scorer was needed for each workstation. Each workstation history is analyzed for any three successive papers where the machine score was discarded, step 177. If it was discarded a report is generated and the machine scoring rubric is re-evaluated and adjusted, step 179. As an example, the factor may be “n” determined by the parameters presently in use, or another appropriate adjustment.

If the answer in step 177 is no, then the previous five successive papers are examined to determine if a machine score is discarded, step 181. If yes, then a report is generated and the machine rubric is re-evaluated and adjusted, step 183. This adjustment may be by a factor of “n-a” or another appropriate adjustment.

If the answer in step 181 is no, then the previous 10 successive papers are examined to determine if a machine score is discarded, step 185. If yes, then a report is generated and the machine rubric is re-evaluated and adjusted, step 187. As an example, the adjustment factor may be “n-a-b” or another appropriate adjustment.

If the answer in step 185 is know the process returns to the beginning.

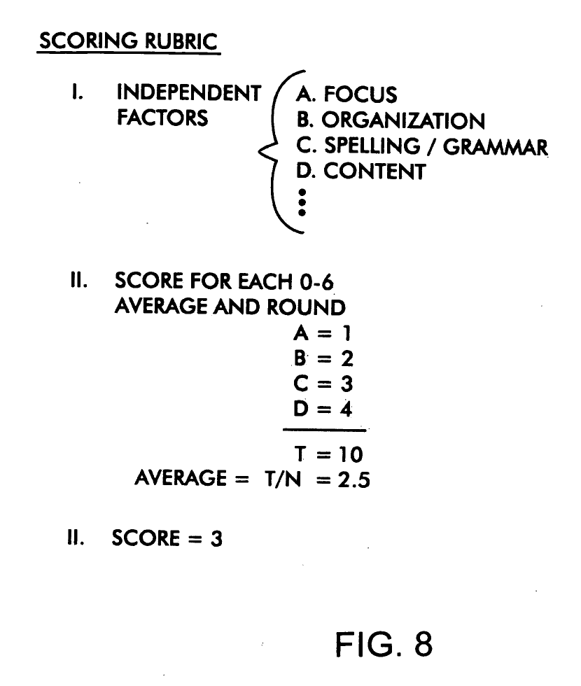

FIG. 8 shows samples of subjects for independent factors in both human and machine scoring of essay assessment test papers, such as: focus, organization, spelling/grammar, content, etc. The score for an essay paper can be the sum of the scores for each factor based on the scale selected. The average is the total sum divided by the number of factors. This number is then rounded to provide the final score.

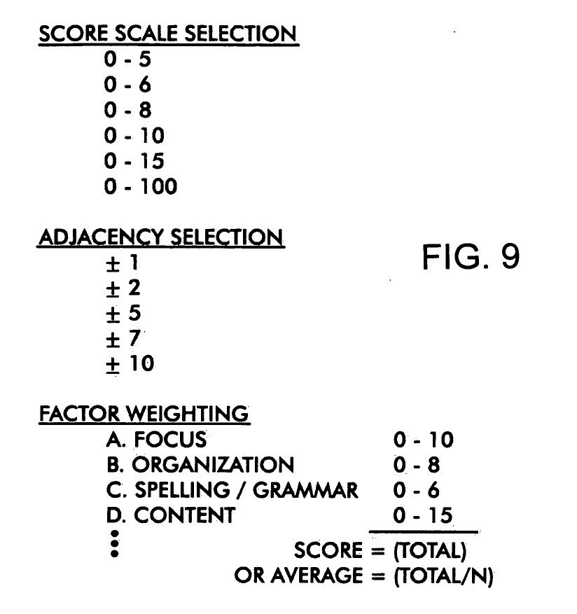

FIG. 9 shows samples of scale selections of various scales that may be used from 0-5 to 0-100. Also shown are samples of adjacency selections for various scales from ±1 to ± minus 10. Obviously, in a rubric where a scale selection of 0-5 is applied with a adjacency at ±1, the effective adjacency is at the same effective same magnitude as in a rubric where a scale of 0-10 is used with an adjacency of ±2. FIG. 9 also shows samples of weighting factors for various independent factors. In the example shown, the focus factor and the content factor are more heavily weighted than the organization factor and the spelling-grammar factor.

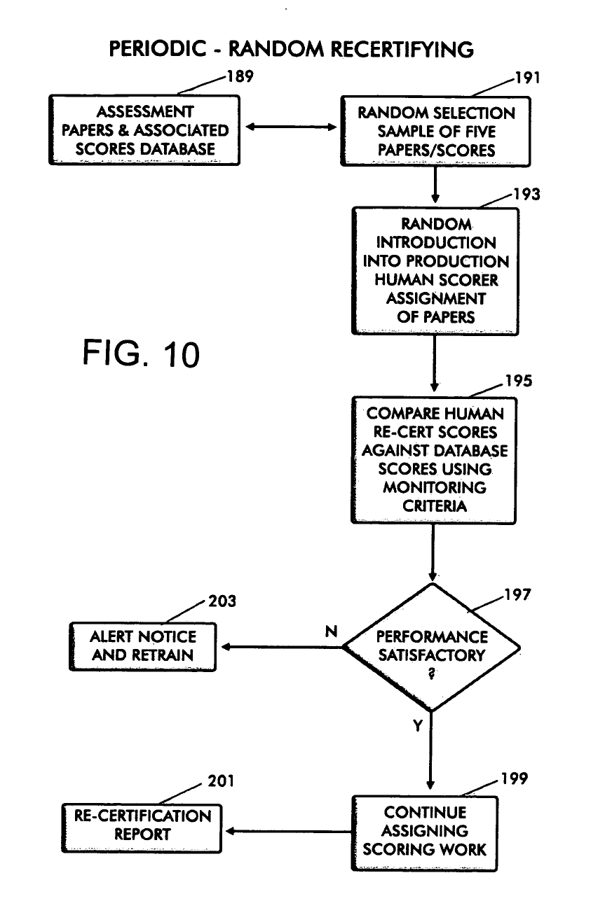

Periodic, random re-certifying is important to maintain the quality of the work product of the human scorers. FIG. 10 shows a routine for managing the random re-certifying of human scorers within the system. This routine operates in conjunction with the routine discussed in connection with FIG. 3. Here, FIG. 10, a database of re-certifying papers and associated scores is accessed, step 189, and a random selection of five papers and scores is downloaded, step 191. These five re-certifying papers are then randomly introduced into the production queue of a human scorer work assignment, step 193. The introduction of re-certifying papers into the scorer's workload is limited to be spread out over a production session and/or a workday so that the re-certification occurs within a time period which reasonably measures the human scorer's present performance. In the random selection of re-certification papers it is also important to select such papers with the same scoring rubric, scale selection, adjacency, weighting factors, etc. as are being presently used by the human scorer in the production run in which the re-certification papers are introduced.

As a human scorer scores a re-certification paper the human score is compared to the ideal score from the database, step 195. Thereafter it is determined if the human score is within adjacent agreement with the ideal score and if the performance history for the scored re-certification papers is satisfactory, step 197. If the performance is satisfactory, the system continues to assign scoring work to that human scorer, step 199, and generates a re-certification report, step 201.

If the performance of the human scorer as determined by step 197 is not satisfactory, an alert notice is sent to the human scorer, production work ceases and the human scorer is retrained, step 203.

It is to be understood that in the discussions herein above that when a report is recited as being printed, that need not exactly happen. As the system and software are resident and implemented in a computer environment, is computer implemented, the report is “generated”, which report may then be sent to the administrator's workstation screen, or be physically printed on a printer. However, what first occurs is that the database of certification and re-certification information on the human scorer is updated and control signals and electronic notices associated with the new updates are distributed within the network and/or the server system as directed by the management software.

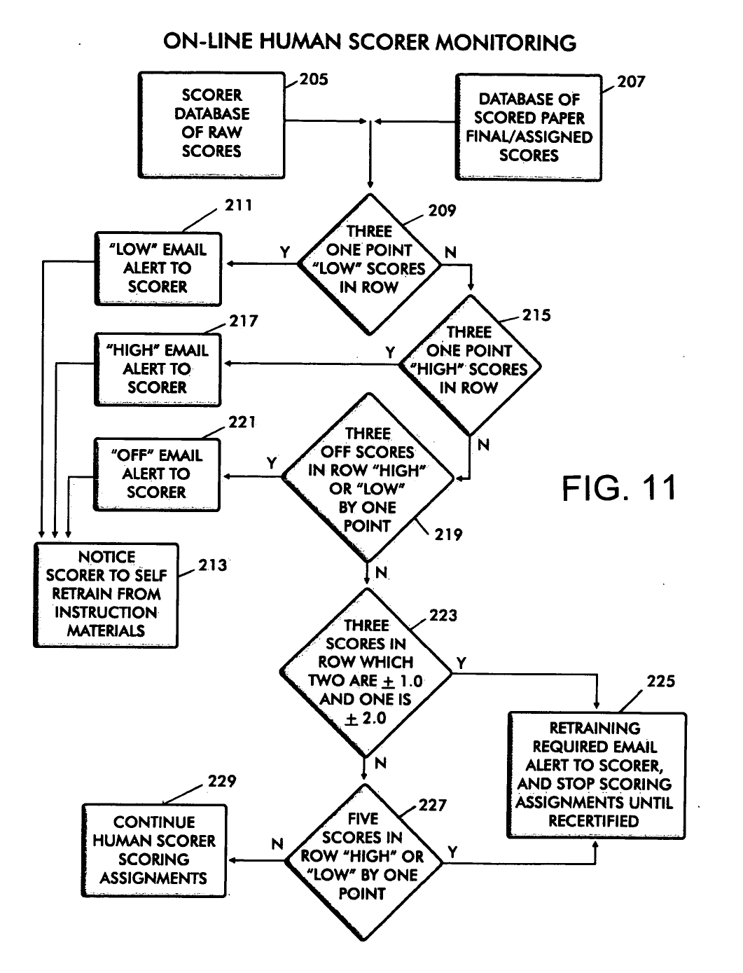

The system also incorporates human scorer monitoring, FIG. 11. This routine keeps a database of each human scorer raw scores, step 205 and a database of each scored paper with final assigned scores, step 207. The raw and adjusted/assigned scores for each scored paper are compared to determine when there are three one-point “low” raw scores in a row, step 209. When that occurs, an alert email for “low” scoring is sent to the human scorer, step 211. This is followed by a notice to the scorer to self-retrain from instruction materials, step 213.

The raw and adjusted/assigned scores for each scored paper are also compared to determine when there are three one-point “high” raw scores in a row, step 215. When this occurs, and alert email for “high” scoring is sent to the human scorer, step 217, followed by a notice for the scorer to self-retrain from instruction materials, this being step 213.

It is understood that the parameter values of steps 209 and 215 can be changed and still be within the present invention. The threshold may be 2 low or high scores in a row for production runs of very high importance, or 4 or more low or high scores in a row for less sensitive production runs. Likewise, when the scoring scale is larger, such as 0-15 or 0-50, the adjacent agreement threshold may be moved from ±1 to a high number, such as ±3, or may be maintained at ±1 for highly sensitive production runs.

This routine also looks for three “off” scores, either “low” or “high”, i.e., a mixed combination, step 219. When this occurs, an “off” email alert is sent to the human scorer, step 221, followed by step 213, the notice for the scorer to self-retrain from instruction materials.

When in a series of three consecutive comparisons generate some scores “off” within the assigned adjacency threshold, but at least one outside the adjacency threshold, step 223, an instruction is emailed or otherwise sent to the human scorer that retraining is required, stop scoring until re-certified, step 225.

If the three consecutive comparisons of step 222 are not detected, then the system looks to five consecutive scores off, but within the adjacent agreement threshold, step 227. If this is detected, then the retraining, stop scoring until re-certified notice is sent, this being step 225.

The system keeps a database of all alerts and notices by content, date and time, and human scorer ID. The system administrator oversees the monitoring and production scheduling of the system. The parameters for number of successive scores for steps 209, 215, 219, 223, and 227 are by way of example and may be varied to meet other standards for any production run. The specification of adjacency threshold for these steps 223 and 227 are also by way of example and may likewise be changed to meet the prescribed standards.

When no alerts are generated, the human scorer continues to receive scoring assignments, step 229.

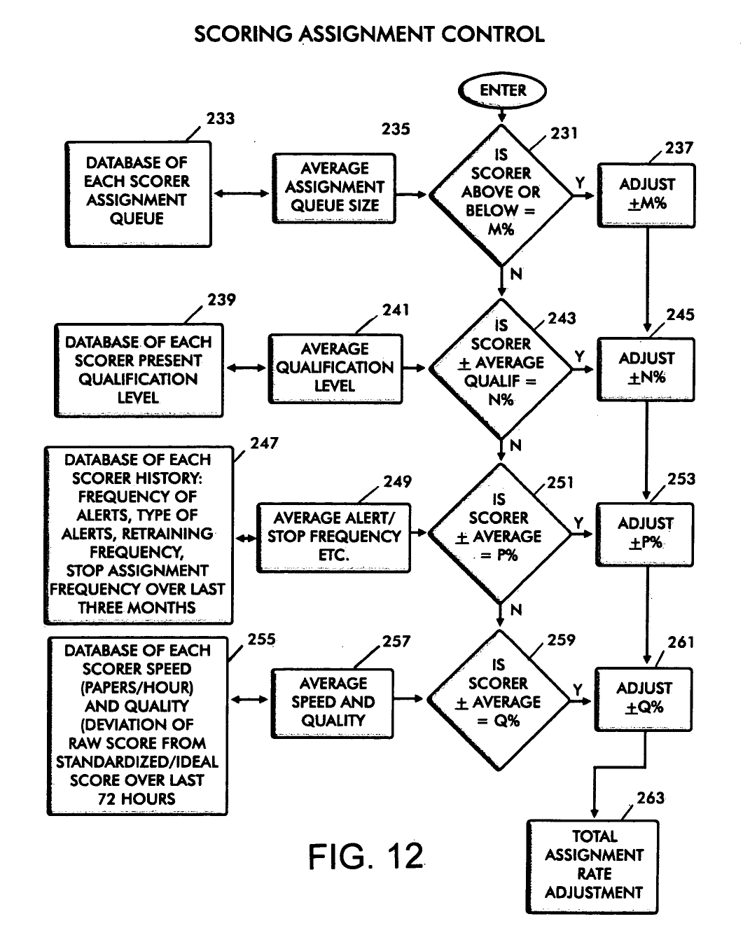

The system also performs human scorer assignment control, FIG. 12. This routine first looks to determine if the scorer is above or below the average production rate of all scorers, step 231. The decision performed in step 231 utilizes information from a database which is maintained of each scorer's assignment queue (the backlog of assigned papers), step 233, and of the average assignment queue, step 235. It is to be noted that when the system for production work assignments is initiated for any production run, each human scorer is assigned work at the same rate.

Where in step 231, it is determined that a scorer's production is above or below the average by a predetermined percentage amount, “m”, the assignment rate for that human scorer is then generates an adjustment factor (correspondingly increased of decreased) by “m” percentage, step 237.

The assignment control also maintains a database of each scorer's present qualification level (performance and quality qualifications), step 239, and a database of the average qualification level of all scorers, step 241. This information is used to determine if a scorer is presently above or below the average qualification level by a factor of “n” percent, step 243. If a scorer is, then his assignment rate for the human scorer has a second adjustment factor generated by a rate of “n” percent, step 245.

The assignment control further maintains a database for each scorers history of frequency of alerts, types of alerts, retraining frequency, stop notices, step 247. The length of this history can be adjusted to any standard. However, a three-month history generally is all that is relevant to the present work quality of a human scorer. A database of the averages for alerts, stops, retraining frequency for all human scorers is also maintain for an equal period of time, step 249. The assignment control monitors if the a human scorer's frequencies for these events is above or below the average by “p” percent, step 251. If it is, the human scorer has a third adjustment factor generated for a corresponding ±“p” percent, step 253.

The assignment control also further maintains a database for each scorer of his/her production speed, i.e., papers scored per hour and of quality, i.e., deviation of raw scores from ideal score over a specific period, such as the past 72 hours, step 255. A database of average speed and quality of all scorers is also maintained, step 257. The scorer's present speed and quality is monitored to determine if it is higher or lower than a threshold of “q” percent, step 259. If it is, human scorer has a fourth adjustment factor generated corresponding to ±“q” percent, step 261.

The actual numeric values for the percentages of steps 231, 243, 251, 259 are set by the administrator. This is likewise true for the percentage adjustments for steps 237, 245, 253, and 261. Moreover, the numeric values for “n” or “m” or “p” or “q” do not need to be the same between the respective monitoring steps and adjustment steps. As an example, where the monitoring step 231 may monitor for “n” percent equal to 5%, the adjustment step may adjust for “n” percent equal to 2%. The various adjustment factor steps 237, 245, 253, 261 are intended to be individually weighted.

The total assignment adjustment rate for the human scorer becomes the sum of the individual four adjustment factors or is determined by some algorithm utilizing the four adjustment factors, step 263. However, the system assignment control, FIG. 12, total assignment rate adjustment, step 263, could also be programmed to depend on any combination of the four adjustment factors, “m”-“q”, or just one of them, or upon other factors determined relevant by the system administrator.

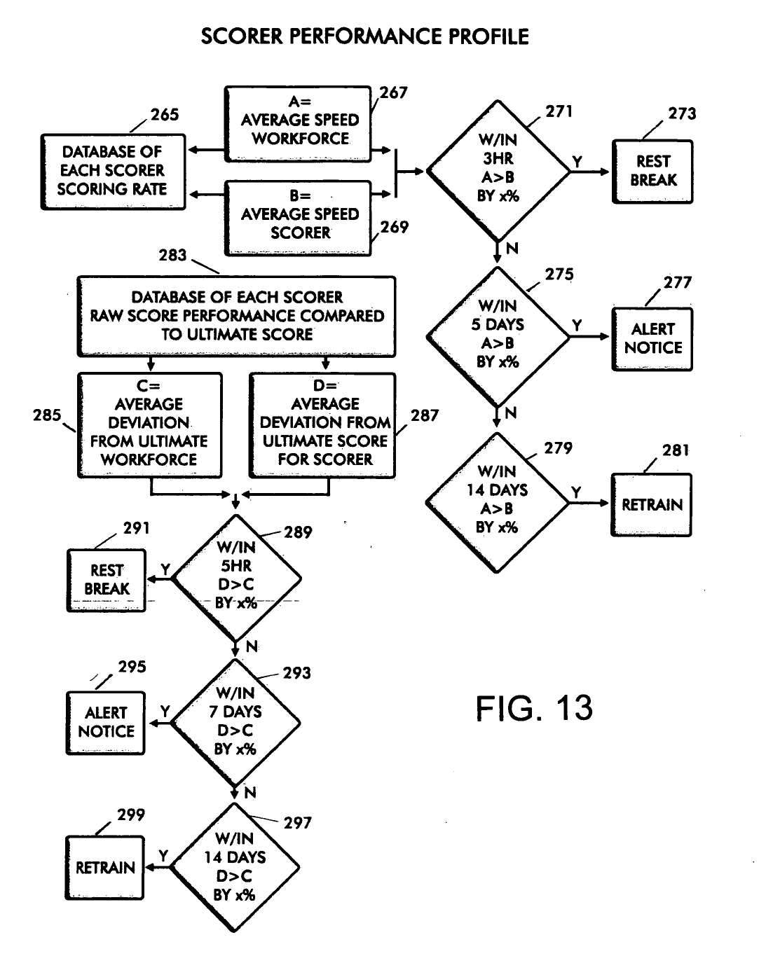

The system provides scorer performance profiles, FIG. 13. This is generated and kept for each human scorer and may even be generated and kept for the machine scoring engine.

A database is generated of each scorer's rate, step 265, from which is generated a database of the average speed of the workforce, step 267, and a database of the average speed of each individual human scorer, step 269. These values are compared over a selected relevant work period, such as for example a period length chosen in the range of two to four hours, to determine if the average speed of the workforce exceeds that of the individual by a threshold percentage, step 271. If it does, then the human scorer is alerted to take a rest break, step 273.

Similarly, the routine monitors each human scorer's average speed compared to the average workforce speed over a longer period of time, such as one selected from the range of 3 to 9 days, step 275. If for this longer period, the average workforce speed exceeds the average production speed of a human scorer by a predetermined threshold, step 275, then an alert notice is sent to that scorer, step 277. It is expected that the alerted scorer will self-train from instruction materials following the alert of step 277.

The routine continues to monitor each human scorer's production performance for longer periods, also, such as the last 14 days, step 279. If a human scorer's average production speed drops below a threshold percentage of the average workforce production speed, step 179, the scorer is notified to report for retraining, step 281, and to cease scoring until re-certified.

Other data can also be gathered and monitored on each human scorer's performance. A database is kept of each scorer's raw score along with the ultimate score awarded to each paper, step 283. From this database is calculated the average deviation for the raw scores from the ultimate scores awarded for the entire workforce, step 285, and the average deviation for the raw scores from the ultimate scores awarded for each paper for each human scorer, step 287. From this information, is calculated the same type of inquiries as in steps 271, 275 and 279.

However, as this type of scoring bias may be more subtle than the previous type, the monitoring periods may by slightly longer for each threshold measurement. Such as, an individual scorer's discrepancy in average deviation of raw to ultimate scores, step 289, may be for the last 5 hours, where in step 271 regarding average speed, it may be for the last 3 hours. When in step 289 the average deviation discrepancy exceeds the selected threshold, a rest break alert is sent to the scorer, step 291.

Likewise, these average deviation values are also monitored for a longer period of time such as the last 7 days, step 293. If the average deviation for a human scorer exceeds the average deviation for the workforce by a selected threshold, an alert notice is sent, step 295. The scorer is expected to make adjustments, such as self-training from instructional materials.

If an individual scorer's average deviation exceeds the workforce average deviation by a selected threshold for a longer period of time, such as 14 workdays, step 297, a retrain notice is sent to the scorer, step 299, and the scorer is expected to immediately cease scoring.

It is to be understood that when any alert or other notice is sent to a scorer's workstation, the reason for the notice is also indicated. The system server also keeps a databases of all notices for each scorer so that the administrator, or the system software can interrogate each scorer's record for a pattern of errors or bias or unusual workflow for each scorer.

The system provides various reports and messages. Table 1 is a sample of a scoring session status report which may be generated at any time.

TABLE 1
(Sample) SCORING SESSION STATUS REPORT

| Date Range: Last Week | | | |
|---|---|---|---|
| Scoring Analysis | | | |
| Number scored by IM, not yet sent to scorers: 2,414 | | | |
| Number sent to first scorers and scored: 2,604 | | | |
| Number sent to first scorers, not yet scored: 4,722 | | | |
| Number sent to second scorers and scored: 463 | | | |
| Number sent to second scorers, not yet scored: 830 | | | |
| Number sent to Chief Reader and scored: 204 | | | |
| Number sent to Chief Reader, not yet scored: 126 | | | |
| Number Complete: 14,300 | | | |
| Distribution of Scores: | | | |
| Score Point | Observed | | |
| 1 | 3% | | |
| 2 | 6% | | |
| 3 | 20% | | |
| 4 | 45% | | |
| 5 | 16% | | |
| 6 | 10% | | |
| Comparison with Expected Distribution: | | | |
| Score Point | Observed | Expected | Difference |
| 1 | 3% | 5% | −2 |
| 2 | 6% | 9% | −3 |
| 3 | 20% | 24% | −4 |
| 4 | 45% | 43% | +2 |
| 5 | 16% | 12% | +4 |
| 6 | 10% | 7% | +3 |

Table 2 is a sample of a scorer monitoring report which is generated periodically and for which the most current report and the report history are available when recalled from a database.

TABLE 2
(Sample) All Scorer Monitoring Report

Date Range: Last Week
Sort by: (scorer number, number of responses, exact,
adjacent, discrepancy)

| Scorer | Number of | | | | Mean | Stand |
|---|---|---|---|---|---|---|
| Number | Responses | % Exact | % Adj.. | % Descrep. | Score | Deviation |
| 120 | 134 | 64 | 34 | 2 | 4.23 | .64 |
| 121 | 102 | 70 | 27 | 3 | 3.96 | .71 |
| 124 | 46 | 64 | 34 | 2 | 4.14 | .80 |
| 125 | 83 | 62 | 36 | 2 | 4.02 | .64 |
| 133 | 136 | 66 | 32 | 2 | 3.81 | .58 |
| 142 | 122 | 58 | 38 | 4 | 3.72 | .61 |
| 144 | 18 | 72 | 26 | 2 | 3.40 | .62 |
| 145 | 15 | 61 | 34 | 5 | 3.71 | .58 |

Individual Scorer Monitoring Report:
Scorer Number: 120
Date Range: Last Week
Summary Data:

| Number of | | | | | Stand |
|---|---|---|---|---|---|
| Responses | % Exact | % Adjust | % Discrep | Mean Score | Deviation |
| 134 | 64 | 34 | 2 | 4.23 | .64 |

Scorer Analysis:

| Scorer | Scorer | | | Recommended |
|---|---|---|---|---|
| Tendency | Productivity | | | Action (None, |
| Index | Index | % Low | % high | Retrain, Stop) |
| (−10 to +10) | (1-10) | (0-100%) | (0-100%) | |
| +4 | 9 | 11 | 25 | Retrain |

Table 3 is a sample of the types of monitoring emails which may be sent to a human scorer.

TABLE 3
(sample) MONITORING EMAILS

Email messages:
Scoring too high!
Scoring too low!
Call for retraining!
Scorer (number) is aberrant
Scorer (number) is very aberrant

The computer software implemented scoring engine used may have its operating parameters re-evaluated for any specific production run. These machine scoring engines can be implemented with a commercial product, such as the Vantage Technologies Knowledge Assessment, LLC INTELLIMETRIC ™ software product, or with a custom written product. Table 4 is a sample of various scoring engines which may be employed individually or in various combinations.

TABLE 4
SCORING ENGINES
Rule Engine - evaluates deviations in scores

Assignment Engine - assigns essays based upon
1. scorer qualifications
2. scorer load
3. essay history of scoring
4. standardized deviation of recent scoring
Performance Engine - monitors each scorers recent performance for
1. speed
2. quality as equal to raw score of essay v. standardized score for essay
History Engine - develops pattern of a scorer being
1. high
2. low
3. within tolerance
Chief Scorer Engine - sets prompt for the chief scorer participation when
1. paper has been scored 3 times and 2 match + or − 1
2. paper has been scored 3 time and none match
3. paper has been scored 3 times and none are adjacent
Scoring Repetition Engine - develops prompts on the number of times to score a paper
1. 2 times if scores differ by 2 points on a 4 point scale, i.e., 0-4
2. 2 times if scores differ by 2 points on a 5 point scale (0-5) or 6 point (0-6) scale
3. 3 times if scores differ by 3 points on a 4, 5, or 6 point scale
4. 3 times if scores differ by more than 3 points

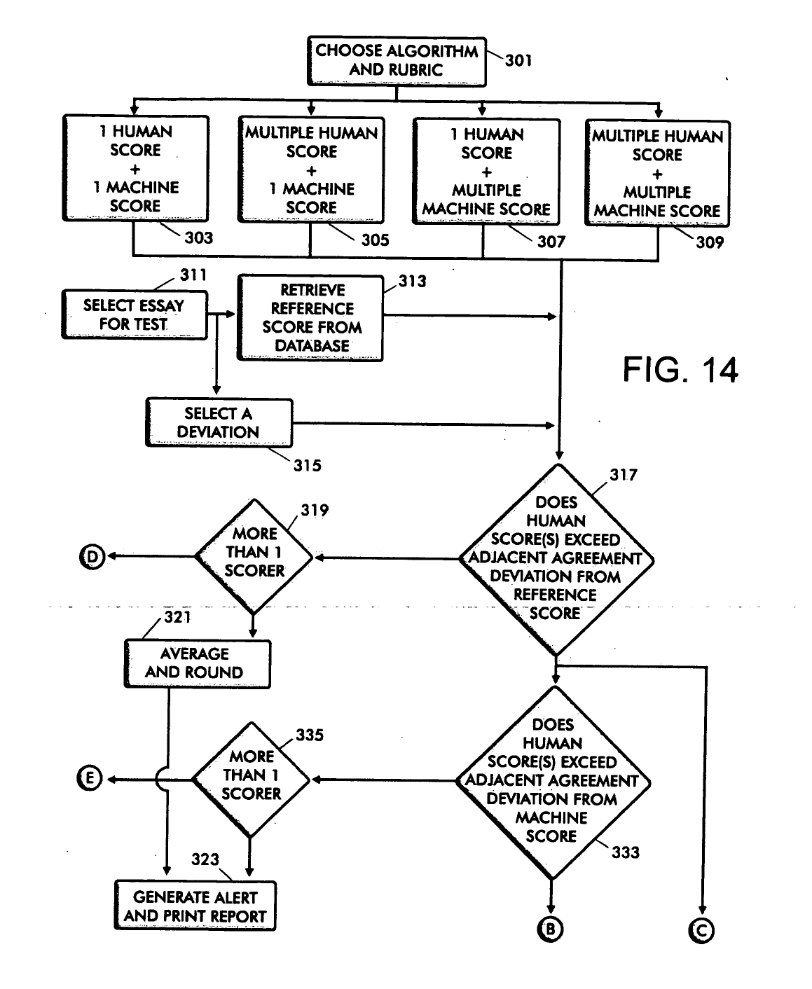

The software algorithm and rubric for a human-machine multiple integrated scoring station system is shown in FIG. 14. The algorithm and rubric(s) are chosen according to the critical nature of the test being scored, the desires of the examining body (customer) administering the scores, and other factors, step 301, FIG. 14. As an example, various scenarios may be selected from: one human and one machine, step 303; multiple humans and one machine, 305; one human and multiple machines, 307; to multiple humans and multiple machines, 309. While the preferred is one human and one machine score per paper, other scenarios are possible and may be desirable depending upon the circumstances.

Once the processing parameters are selected from steps 303-309 et al., an essay is selected for testing, step 311, and the reference score is retrieved from a database, step 313. The reference score is the correct or ideal score for the essay as determined by the master scorer or other authority. With this information a deviation is selected for the adjacency threshold for scoring the selected paper, step 315.

With the paper then having been scored by the human scorer(s) and the machine(s), the system then determines if the human score(s) exceed the adjacent agreement deviation threshold from the reference score, step 317. If yes, it is determined if there is more than one scorer, step 319. If not, then the scorer's score is averaged and rounded, step 321, and an alert is generated and a report printed, step 323.

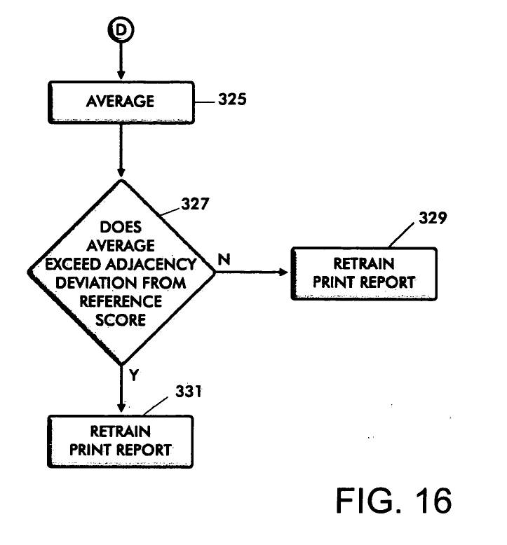

If in step 319 there is more than one scorer, the scores are averaged, step 325, FIG. 16. Thereafter it is determined if the average exceeds the adjacency deviation threshold from the reference score, step 327. If no, a retrain alert is generated and a respective report is printed, step 329. If it does, a retrain alert is generated and a respective report is printed, step 331.

Returning to FIG. 14, step 317, if any of the human scores do not exceed the adjacency deviation threshold, then those scores are examined to determine if any exceed the adjacency deviation threshold from the machine score, step 333. If yes, it is then determined if there is more than one human scorer, step 335. If there is not more than one human scorer than an alert is generated to that scorer and the system database and a report is generated, this being step 323.

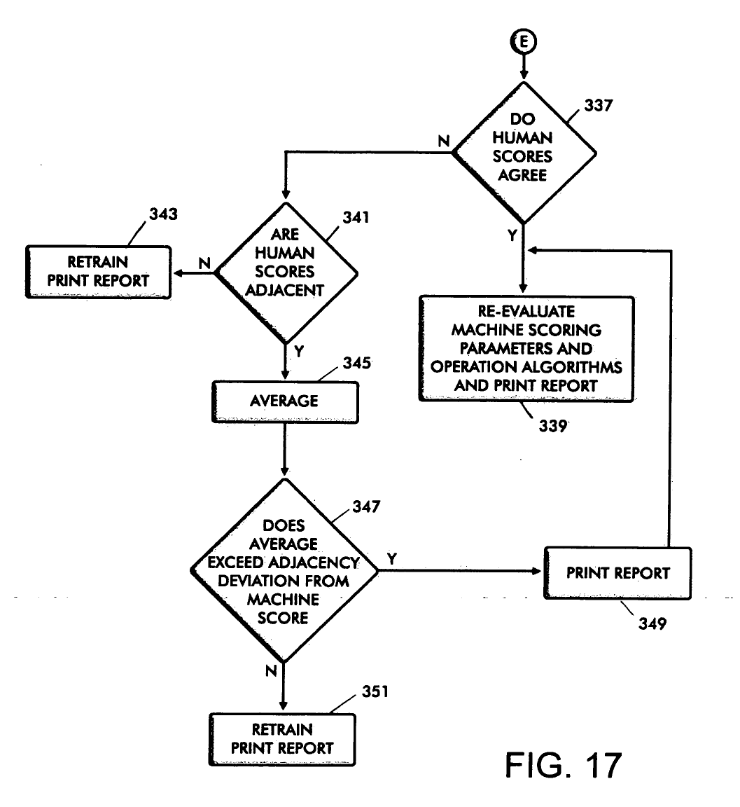

If there is more than one human scorer determined in step 335, then the human scores are examined to determine if they are in exact agreement, step 337, FIG. 17. If they are in exact agreement, then a report and an alert is generated to re-evaluate the machine scoring parameters, operational algorithms and rubrics, step 339.

If in step 337 the human scores do not agree, it is then determined if the human scores are in adjacent agreement, step 341. If not, a retrain notice and alert is generated to each human scorer and an appropriate report is generated, step 343.

If in step 341 the human scores are in adjacent agreement, then the scores are averaged, step 345. Thereafter, the average is examined to determine if it exceeds the deviation threshold for adjacency from the machine score, step 347. If the average exceeds the adjacency agreement threshold, then a report is generated, step 349, and the machine scoring parameters, algorithms and rubrics are re-evaluated and a report is generated, step 339.

If in step 347, the average does not exceed the adjacency deviation threshold with the machine score, a retrain alert is generated for each human scorer and a report is generated, step 351.

If in step 333, FIG. 14, the human score(s) do not exceed the deviation threshold for adjacency with the machine score, the machine score is examined to determine if it is exact with the reference score, step 353. If yes, then a history report is generated, step 355.

If the machine score is not in exact agreement, then it is examined to determine if it exceeds the deviation threshold for adjacency, step 357. If it does, then the machine scoring parameters, algorithm and rubrics are re-evaluated and an appropriate report and history is generated, step 359.

If in step 357, the machine score does not exceed the adjacency deviation threshold, then the scorers are averaged, then it is determined if more than one score is to be averaged for the particular reference test paper, step 361. If there is more than one, then the scores are averaged and rounded, step 363, and an electronic record is generated with a relevant report, step 365.

If in step 361, there is to be no averaging, the scorer's identification is interrogated to determine if it was a machine score, step 367. If not a machine score, then the scorer's identification is examined to determine if it was a human scorer, step 369. If a negative result occurs in step 369, a human scorer assigned the selected test essay (i.e., the selected reference essay) and an alert is generated, step 371. If a positive response is received from either step 367 or step 369, an electronic record is generated with a relevant report, this being step 365.

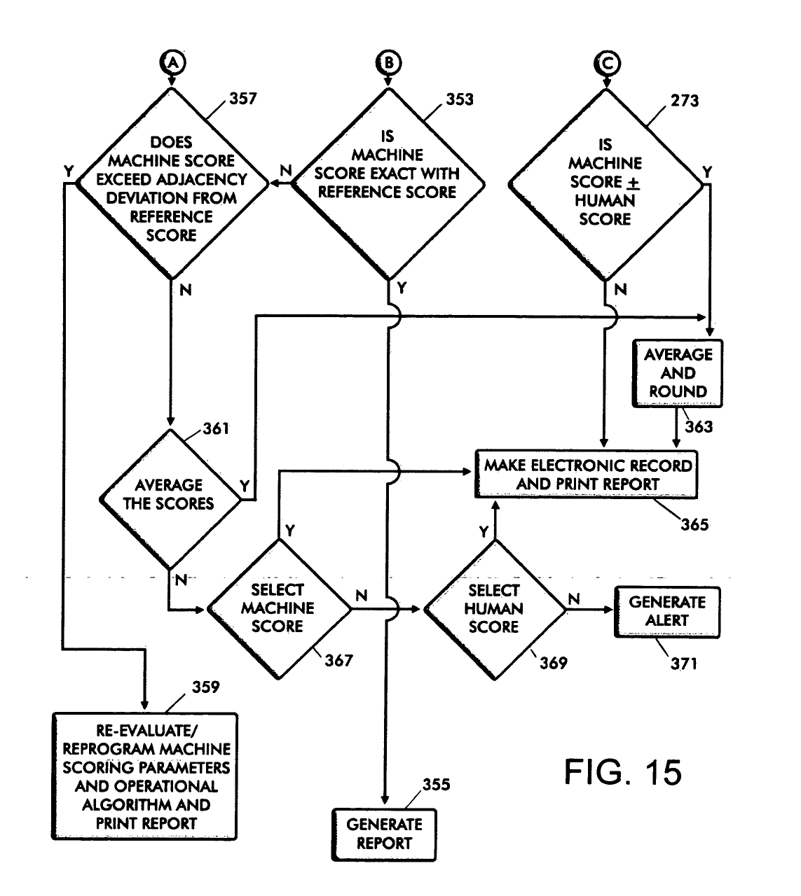

For a negative outcome from step 317, FIG. 14, not only is step 333 next performed, but also the scoring status is examined to determine if there is more than one human score, step 373, FIG. 15. If there is more than one human score, the scores are then averaged, step 363, FIG. 15 and an electronic record and report are generated, step 365.

If in step 373 it is determined there is only one human score, an electronic record and report are generated, step 365.

It is to be understood that the software disclose above in relation to the logic diagrams is resident in the server or servers. The selection between a single server and multiple servers is a matter of choice based upon the size and speed of the equipment commercially available and the LAN, internet, or other cabling connections required for the system as a function of the system size for meeting the production demands and physical location of the workstation force(s).

Many changes can be made in the above-described invention without departing from the intent and scope thereof. It is therefore intended that the above description be read in the illustrative sense and not in the limiting sense. Substitutions and changes can be made while still being within the scope and intent of the invention and of the appended claims.

What is claimed is:

1. A system for obtaining integrated essay scoring from multiple sources, comprising:
a quantity of essay assessment test papers to be scored, said test papers each having an associated identification;
means for transforming said test papers and identification into electronic records in a first database;
at least one human scorer for scoring electronic records of test papers assigned thereto;
at least one machine scorer for scoring electronic records of test papers assigned thereto;
means for electronically sequentially assigning a distribution of said electronic records of said test papers from said first database to at least one of said at least one human scorer and to at least one of said at least one machine scorer for scoring in a concurrent time period;
wherein each human scorer scores each test paper assigned and each machine scorer scores each test paper assigned, said scores being provided with said test paper identification and with the identification of said scorer;
means for electronically collecting said test paper scores and for storing said test paper scores and associated identification in a second database;
means for analyzing for any differences in the scores of each test paper scored;
means for resolving discrepancies in the analyzed scores for each test paper in said second database; and
means for providing a resultant score for each test paper where scoring discrepancies existed;
wherein said difference analyzing means also includes means for monitoring the performance of each scorer and alarming plural types of undesirable performance for said scorer.

2. The system of claim 1, wherein said analyzing means includes means for determining for an exact agreement between scores for a said test paper and assigning that score as the resultant score for said test paper, wherein said resolving discrepancy means includes means for determining adjacent agreement between scores for said test paper and averaging said scores in the presence of adjacent agreement and assigning that average score as the resultant score for said test paper, and wherein said resultant score providing means includes means for assigning said test paper to a master scorer for scoring in the absence of exact and adjacent agreements of said test paper scores.

3. The system of claim 2, wherein there is one human scorer for scoring a said test paper for providing a first score thereof and one machine scorer for scoring said same test paper for providing a second score thereof, and wherein there is also including means for assigning said test paper to a second human scorer for providing a third score thereof, said second scorer assigning means making said assignment in the absence of exact and adjacent agreement between said test paper first two scores and prior to said test paper being assigned to said master scorer, and also including means for determining an exact agreement and an adjacent agreement between any to of said three scores, discarding the odd score and providing said resultant score as an exact agreement score of an average score when adjacency exists between said two scores.

4. The system of claim 3, wherein there are at least two human scorers, and wherein said distribution assigning means is programmed to distribute separate ones of said test papers to one of said human scorers for scoring and each of said test papers to said machine scorer for scoring.

5. The system of claim 4, wherein said distribution assigning means is programmed to distribute separate ones of said test papers to two of said human scorers and to said machine scorer for scoring.

6. The system of claim 5, also including means for determining if the machine scorer needs adjustment, said machine scorer determining means including means for determining if three successive scored papers have had the machine score discarded as odd, and including means for determining if five successive scored papers have had the machine score discarded as odd, and including means for determining if 10 successive scored papers have had the machine score discarded as odd, said three, five, and 10 odd discard determining means each providing a respective alarm and report.

7. The system of claim 4, also including means for certifying the competency of each human scorer, said certifying means including means for first determining if the scorer to be certified is a new scorer or a retuning scorer to be retrained, means for administering a plural item standardized test to new and returning-retrain scorers, a third database of desired test scores for said administered standardized test, means for determining if the new or retrained scorer performance is satisfactory as compared to said associated desired test scores, means for certifying tested scorers with satisfactory performance and providing each with a scorer identification code and assigned work, where said system also includes a fourth database of reference papers and associated desired scores for each thereof, means for assigning three to five reference papers to all other scorers to be re-certified, means for determining said re-certification scorers performance against said fourth database desired reference paper scores satisfactory, and means for decertifying said re-certification scorers and providing each with an identification code and assigned work, wherein said performance determination means also notice unsatisfactory certification and re-certification performances for retraining.

8. The system of claim 4, also including means for human scorer monitoring, said means including a fifth database of raw scores generated by each human scorer, a sixth database of adjusted/assigned scores for each paper scored by each human scorer, means for each human scorer for determining a history of consistent low or high scores within adjacency, and means for providing an alert notice to a respective human scorer consistent with the history determined.

9. The system of claim 4, also including means for scoring assignment control, comprising, a seventh database of each human scorer assignment queue, an eighth database of each human scorer present qualification level, a ninth database of each human scorer history of alarm performance including alerts, retraining, stop working, a tenth database of each human scorer speed and work quality for a selected recent period, means associated with said seventh database for calculating the average assignment queue size for the human scorer workforce and for determining if each human scorer is above or below said average assignment queue and determining a respective +/− queue factor, means associated with said eighth database for calculating the average qualification level for the human scorer workforce and for determining if each human scorer is above or below said average qualification level and determining a respective ± qualification factor, means associated with said ninth database for calculating the average alert, retraining and stop notice frequency for the human scorer workforce and for determining if each human scorer is above or below said average alert level and determining a respective ± alert factor, means associated with said tenth database for calculating average speed and quality for the human scorer workforce and for determining if each human scorer is above or below said average speed and quality and determining a respective ± speed and quality factor, and means for calculating a control signal controlling a change in assignment rate to each individual human scorer as a function of one or more of each said respective factor for said respective human scorer.

10. The system of claim 4, also including means for generating a performance profile for each human scorer comprising, an eleventh database of each human scorer's current scoring rate, a twelfth database of each human scorer raw score performance and the ultimate/assigned score for each raw performance data test paper scored, means for calculating the average speed of the workforce and the average speed each human scorer, means for determining for various time intervals for each human scorer whether said individual human scorer's speed is less than the workforce speed by a selected threshold and generating an associated alert, means for determining the average deviation of the workforce raw scores from the ultimate/assigned score for each test paper, means regarding each individual scorer for determining the each individual scorer's average deviation of raw score from ultimate/assigned score, and means for determining for various time intervals for each human scorer whether said human scorer's raw score deviation exceeds a selected threshold and generating an associated alert.

11. A method of operating a system for obtaining integrated essay scoring from multiple sources, comprising the steps of:
obtaining a quantity of assessment test essay answer papers in electronic form and storing said test answers in a first database;
providing a plurality of production human scorers each operating an on-line workstation for scoring said papers;
providing a computerized machine scorer operating on-line for scoring said papers;
distributing said test answers among individual ones of said human scorers and sending all said papers through said machine scorer;
storing the paper scores in a second database with identifications to said paper and to the identification of the human and machine scorer;
analyzing the scores for each paper to determine exact agreement and adjacent agreement between scores;
recording in a third database a resultant score each paper equal to the exact agreement score between the multiple scores for said paper when exact agreement is present;
recording in said third database a resultant score for each paper equal to the average of the multiple scores for said paper when adjacent agreement between said multiple scores is present; and
assigning a paper to a master scorer for scoring when neither exact agreement nor adjacent agreement between the multiple scores is present for that paper.

12. The method of claim 11, prior to assigning a paper to a master scorer, the steps of:
assigning said non-exact agreement and non-adjacent agreement paper to a second human scorer;
comparing the three scores from said first and second human scorers and said machine scorer for exactness and for adjacency and discarding the odd score if either exists;
assigning an exact score as the score for said test paper if exactness exists; and
assigning the average of the two remaining scores as the score for said test paper is adjacency exists.

13. The method of claim 13, also including a process for machine scorer adjustment comprising for each time said machine score is the odd score discarded determining if there has been a succession of machine score discernments for various histories of papers and generating a report respective of and relevant to the history determined.

14. The method of claim 11, also including a method of random human scorer re-certifying comprising selecting a random sample of pre-scored standardized papers and introducing them into a scorer's assignment, comparing the scorers score response for the standardized papers against a desired score and either re-certifying or retraining the human scorer as a function of his performance.

15. The method of claim 11, also including a method of monitoring each human scorer comprising determining if a said human scorer has a scoring bias of continually scoring high or continually scoring low and providing an appropriate alert as a function of the scoring history determined.

16. The method of claim 11, also including a method of scoring assignment rate control comprising determining if each said human scorer is performing above or below the average of the workforce for queue size, qualification level, alert frequency, and average speed and quality, generating a respective individual assignment rate factor as a function of the individual scorer's deviation from any of the average queue size, the average qualification level, the average alert frequency, the average speed and quality, and adjusting an individual human scorer's assignment rate as a function of said factors.

17. The method of claim 11, also including a method of generating a performance profile for each human scorer comprising calculating the average speed of the workforce, calculating the average speed of each human scorer, determining if each said scorer has fallen behind said average workforce speed by a selected threshold for a selected period of time and providing an notice to said human scorer selected from rest break, alert, retrain depending upon the period of time said human scorer has been behind the workforce average speed.

18. The method of claim 11, also including a method of human scorer certifying comprising determining if a human scorer is a new scorer to be certified or a returning scorer to be re-certified or other, if said human scorer is new or returning, administering a standardized plural item test for which a reference scores are predetermined, and determining if the human scorer's performance was satisfactory, certifying a satisfactory human scorer and retraining an unsatisfactory human scorer, and if said human scorer is not new or returning then assigning a quantity of standardized test papers for which reference scores are known and monitoring the human scorer performance, retraining human scorers with unsatisfactory performance and re-certifying human scorers with satisfactory performance.

19. The method of claim 11, also including a method of human scorer assessment comprising determining threshold values for a human scorer's raw score of a test paper from a desired score, assigning a human scorer a plurality of standardized test papers for scoring each of which the desired score is known, keeping a record of said human scorer's performance as he scores each assigned standardized test paper, and deciding to re-certify or retrain said human scorer as a function of his score history profile.

20. The method of claim 11, also including providing a plurality of machine scorers, selecting a combination of the number of human scorers and machine scorers for a scoring production run, monitoring the performance of the human scorers for raw scores generated against all scores generated for each paper, alerting and retraining when one or more human scorer performance is unacceptable, and alerting and reprogramming one or more machine scorers when their operation is unacceptable.
